(19) United States
(12) Patent Application Publication
(10) Pub. No.: US 2008/0246307 A1
(43) Pub. Date: Oct. 9, 2008

(54) Curb-side debris loader-un-loader

(76) Inventor: Mark Ernest Theener, Meridian, ID (US)

Correspondence Address: Mark E. Theener, 1905 N. Aronmink Way, Meridian, ID, 83646, US

(21) Appl. No.: 11/656,034

(22) Filed: Apr. 5, 2007

(51) Int. Cl. B62D 33/02

(52) U.S. Cl. 296/183.2

(57) ABSTRACT

A load hauling vehicle such as a truck having a truck bed which can load itself from the right side of the truck by use of the right wall being hinged at the bottom adjacent to the truck bed to enable it to be extended (or pivoted) down toward the ground in conjunction with a debris door being attached to the right wall (at the upper side of the wall from the truck bed) which can be used as a platform to place debris on and then lift said debris from ground level into the truck bed. Also the truck bed can be tilted to the left so as to empty a load of debris. The truck bed is raised (tilted) by use of a sub-frame and a hydraulic ram.

| | |
|---|---|
| Current U.S. | 296/11; 296/183.2; 298/19R; 296/61; 414/537; |
| Class: | 49/193; 298/22R; 296/36; 296/57.1; 298/23M |
| Current | B60 1/04(20060101); B60P 1/26(20060101); |
| International | B60P001/26; B60G 11/24 (20060101); |
| Class: | B60G 11/00(20060101); B60G5/00(20060101); |
| | B60G5/02(20060101); B60J5/10(20060101); |
| | B62D53/00(20060101); B62D33/02(20060101); |
| | B62D53/06(20060101); B62D61/12(20060101); |
| Field of Search | 296/11,183.2,184 298/17R, 19R, 22R, 22J, 22P, 22D, |
| | 17SG, 296/61, 51, 56, 57R, 57A, 181 49/193 16/147 |
| | 414/537 296/184, 181, 182, 57.1, 36, 26.12, 26.15 |
| | 298/17R, 22R, 18, 23MD, 23M |

References Cited [Referenced By]

| | | |
|---|---|---|
| 1012203 | December 1911 | Hunt |
| 1440155 | December 1922 | Junkin |
| 1517697 | December 1924 | Barrett |
| 1735408 | November 1929 | Nein |
| 1812915 | July 1931 | Wright |
| 1965476 | July 1934 | Smith |
| 2215631 | November 1940 | Young |
| 2471901 | May 1949 | Ross |
| 2501001 | March 1950 | Neely |
| 2797960 | July 1957 | Enders |
| 2899172 | August 1959 | Cresci |
| 2953408 | September 1960 | Koenig |
| 3094351 | June 1963 | Gwinn, Jr. |
| 3485523 | December 1969 | Carr |
| 4076310 | February 1978 | Schwalm |
| 4346929 | August 1982 | Peters |
| 5271652 | December 1993 | Watanabe |
| 5518287 | May 1996 | Totani |
| 5681095 | October 1997 | Martin |

Foreign Patent Documents

| | | |
|---|---|---|
| 224 17 882 | October 1975 | DE |
| 54-317 | January 1979 | JP |
| 5-58350 | March 1993 | JP |
| 1561058 | February 1980 | GB |

### BACKGROUND OF THE INVENTION

In the past trucks have been designed to dump from the rear or to either side, or all three directions. Other trucks have been designed to load material with a lift gate at the rear or let down one side to allow loading by a fork lift or front-end loader. None have been designed to integrate the side dumping capability with the added function of being able to load debris onto the deck from the ground level with out the aid of a fork-lift, front end loader, or by hand.

This invention pertains to the integrated use of a dump truck bed used as a loading and un-loading machine by adapting the dump bed to load debris from the right side (curb-side) of the truck from ground level to the deck and dump the bed to the left side onto the ground

### OBJECT OF THE INVENTION

The object of this dump bed is to be able to load debris from the curb side when doing landscape maintenance with the use of a hydraulically operated door with a debris door on the right side of the truck.

Another object is the provision to be able to dump the truck laterally to the direction of travel (left side of truck) by means of hydraulics.

The operation of the truck bed consists of lowering the right wall (with the debris door) of the truck bed to the ground level, dumping landscape debris onto the debris door, raising the right wall to it's up-right position. When the truck bed needs to be un-loaded the truck bed can be tilted to the left and unloaded out of the left side wall.

The advantage of this truck bed is to be able to load debris from the curb-side using the debris door without manual labor quickly and economically. Also dumping the load from the left side enables the operator to un-load quickly with-out manual labor and with-out having to un-hook from the obligatory landscape trailer which is used in almost all operations.

### SUMMARY OF THE INVENTION

This invention is a load carrying vehicle such as a truck which has a chassis; a bed mounted on top of the chassis; the bed having a bed bottom, also having a sub-frame to mount a hydraulic hoist to tilt the bed; a front end having a front end wall, a pair of opposed sidewalls, and a rear end having a rear wall; a left wall (lateral to the direction of the front of the truck) having hinges at the top corners of the truck bed so as to be opened; a right wall with the lower edge piano hinged connected to the adjacent edge of the bed bottom to permit the sidewall to be opened downwardly; a debris door piano hinge connected to the upper edge of the right wall; a hydraulic ram in front of the front wall; a hydraulic ram behind the back wall; both of which when connected to a linkage on the front and rear wall and the right side wall will cause the right side door to raise and lower.

### BRIEF DESCRIPTION OF DRAWINGS

FIG. 1 depicts right side of the truck bed with side door in up-right position and debris door folded over the top (rear view).

FIG. 2 depicts right side of truck bed with side door in up-right position and debris door folded over the top (side view).

FIG. 3 depicts right side of truck bed with side door partially down and debris door folded out.

FIG. 4 depicts right side of truck bed with side door mostly down and debris door folded out.

FIG. 5 depicts right side of truck bed with side door completely down and debris door on the ground for loading debris.

FIG. 6 depicts left side of truck bed and shows unloading side door in closed position.

FIG. 7 depicts left side of truck bed and shows truck bed in un-loading position (tilted) with side door deployed in out position.

FIG. 8 depicts rear of truck bed and shows truck bed in raised un-loading position (tilted) and with un-loading side door deployed in the out position.

### DETAILED DESCRIPTION OF THE INVENTION

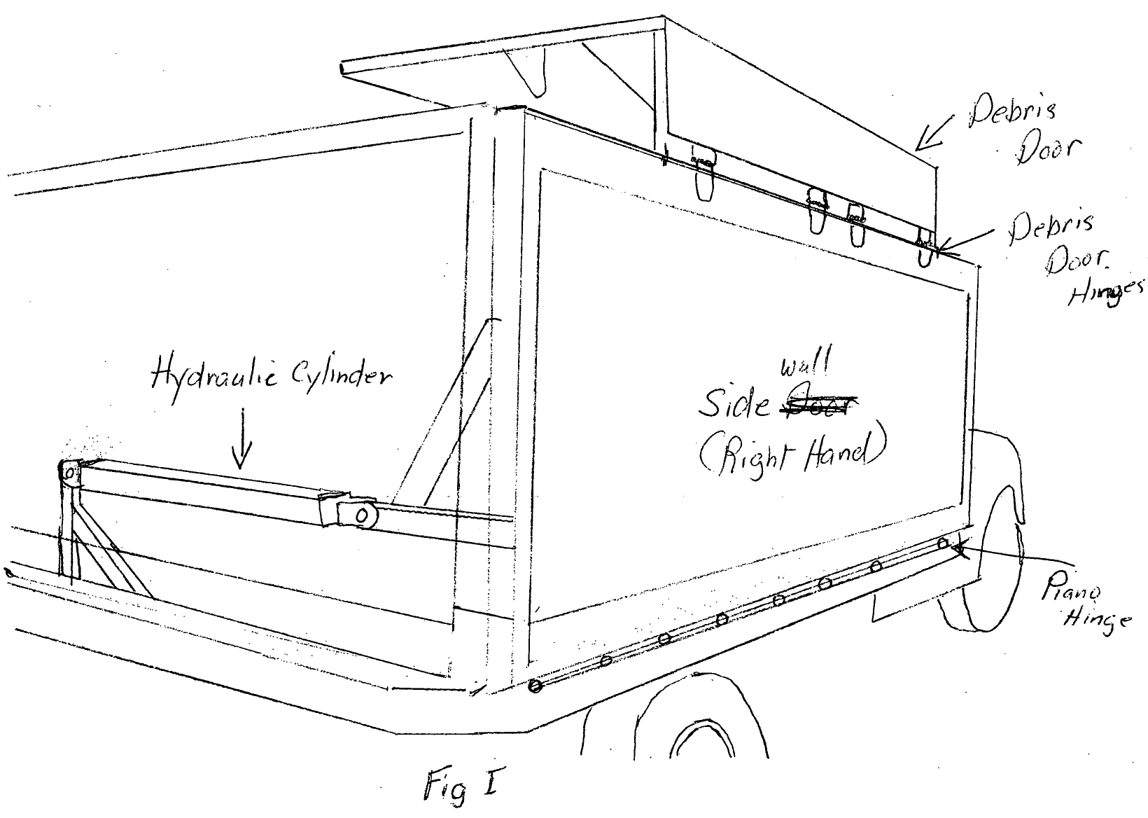

Referring to FIG. 1 of the drawings, a truck is indicated with a truck bed. The truck bed is in the un-tilted position. This drawing shows the right wall of the truck bed in the up-right position. FIG. 1 shows the hydraulic ram and linkage for the ram at the rear of the bed in the closed position, the indicated piano hinges on the lower right wall adjacent to the bed bottom. FIG. 1 shows the debris door in the closed position and the position of the piano hinge attaching it to the right side wall.

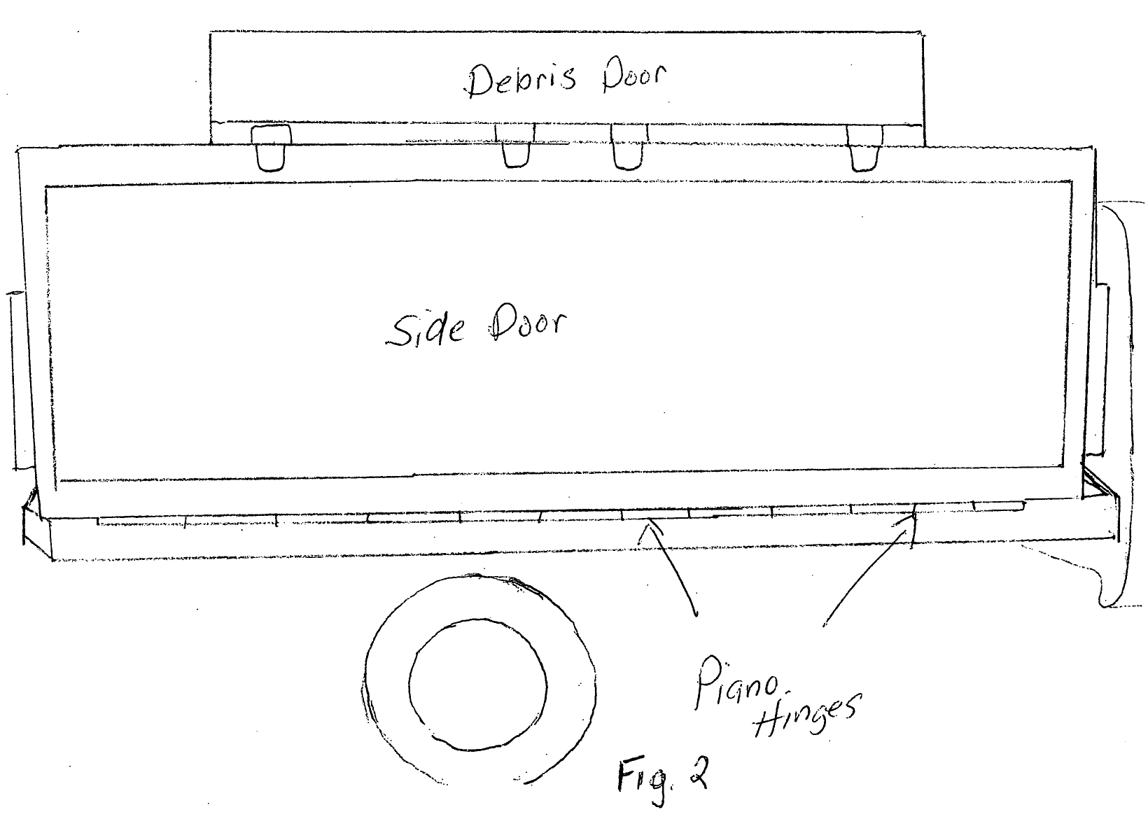

Referring to FIG. 2 of the drawings, a truck with a truck bed. The truck bed is in the un-tilted position. This drawing shows the right side wall and the piano hinges that attach this wall to the truck bed at the bottom of the right side wall. This drawing also shows the debris door with the piano hinges that attach the debris door to the upper edge of the right side door. The debris door is in the transport position.

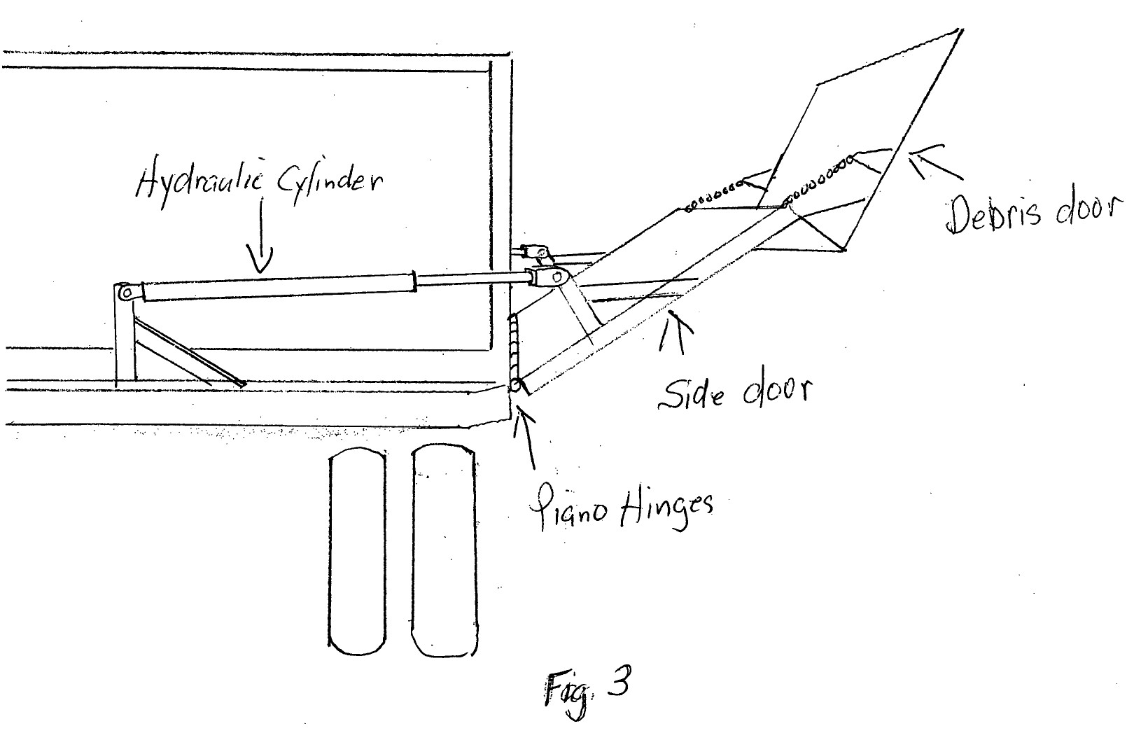

Referring to FIG. 3 of the drawings, a truck is indicated with a truck bed. The truck bed is in the un-tilted position The drawing shows the right wall of the truck bed in a partly lowered position (approximately 45 degrees) with the hydraulic cylinders partially extended and the debris door deployed to the outer position as it has pivoted on it's piano hinges and is restricted from pivoting further by the adjustment/safety chains.

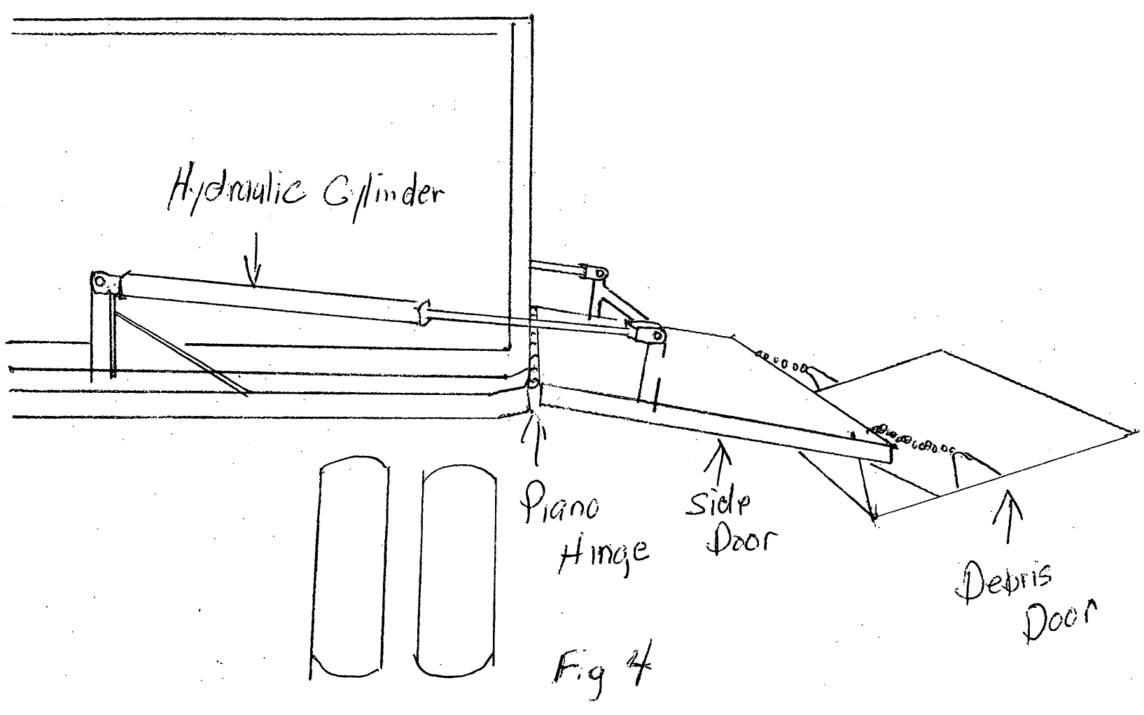

Referring to FIG. 4 of the drawings, a truck is indicated with a truck bed. The truck bed is in the un-tilted position. The drawing shows the right wall of the truck bed in a more lowered position than FIG. 3 with basically the same characteristics. The hydraulic cylinders are more extended, the debris door is deployed to the outer position in the same position as FIG. 3

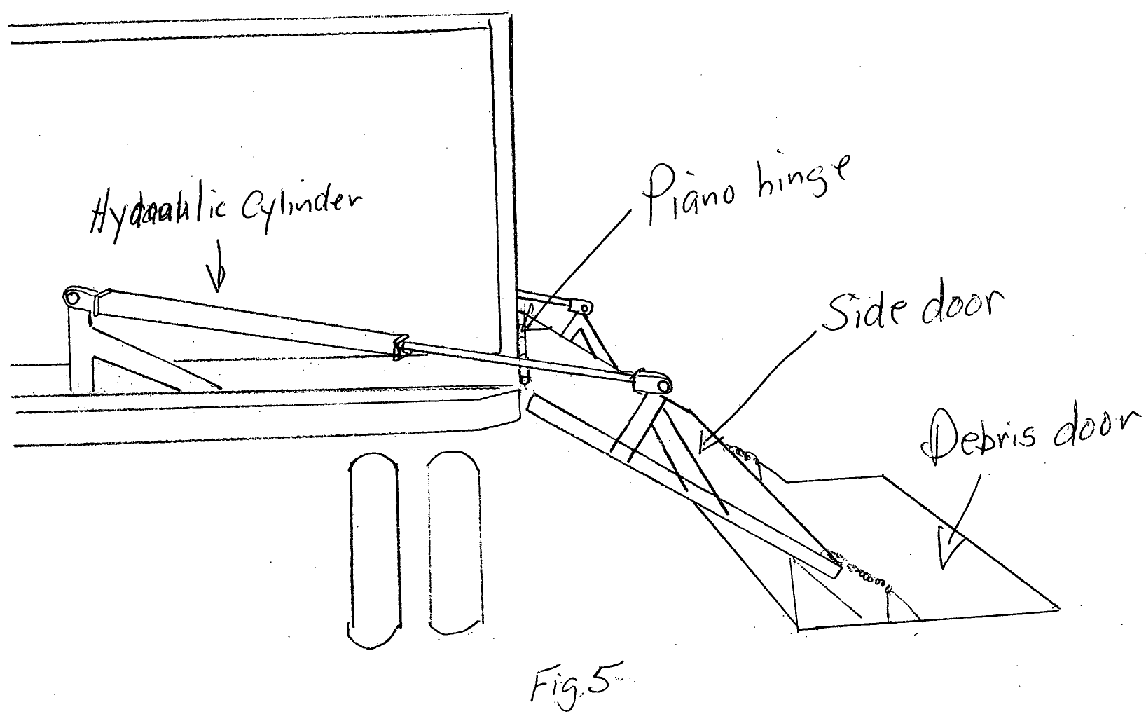

Referring to FIG. 5 of the drawings, a truck is indicated with a truck bed. The truck bed is in the un-tilted position. The drawing shows the right wall of the truck bed in the fully lowered position with the hydraulic cylinders fully extended and the debris door is resting on the ground and is ready to have debris placed on it so as to be elevated back up into the truck.

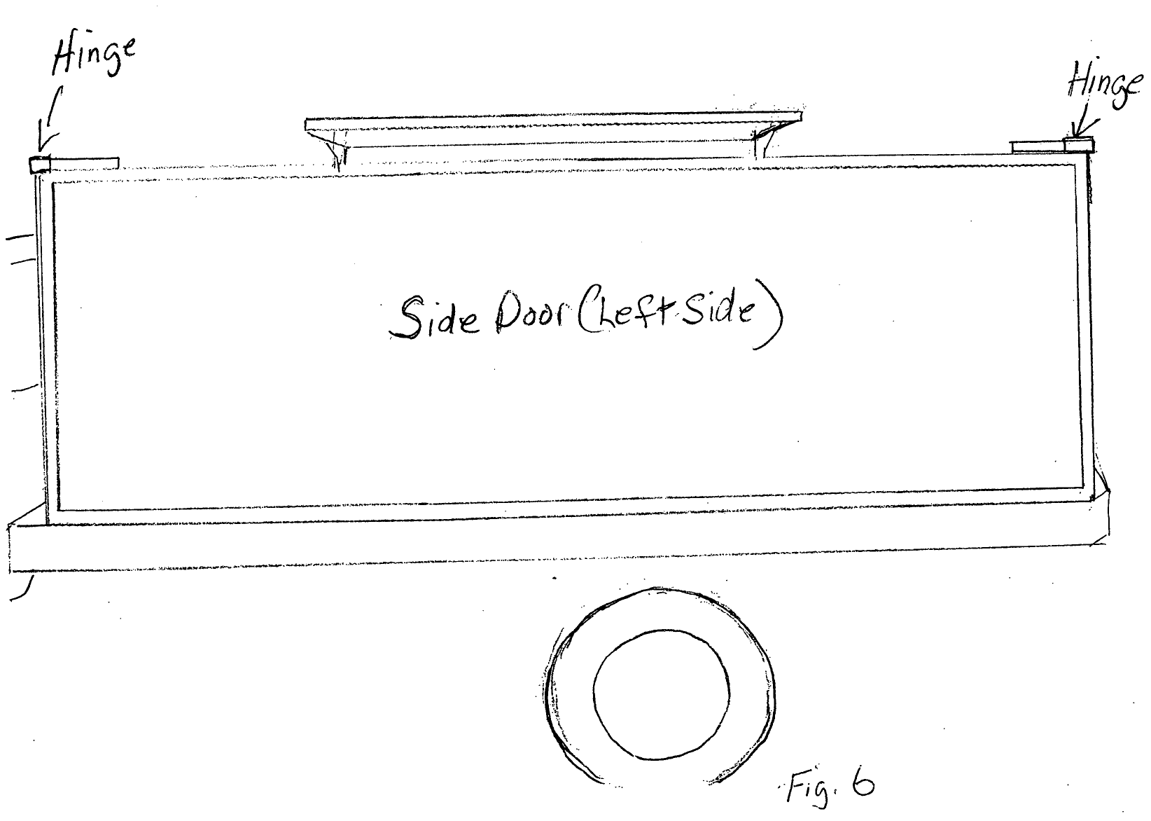

Referring to FIG. 6 of the drawing, a truck is indicated with a truck bed. The truck bed is in the un-tilted position. The drawing shows the left wall of the truck bed in the closed position with the hinges indicated on the upper corners of the side wall. A latch is used to secure the door in the closed position but no latch is indicated in these drawings.

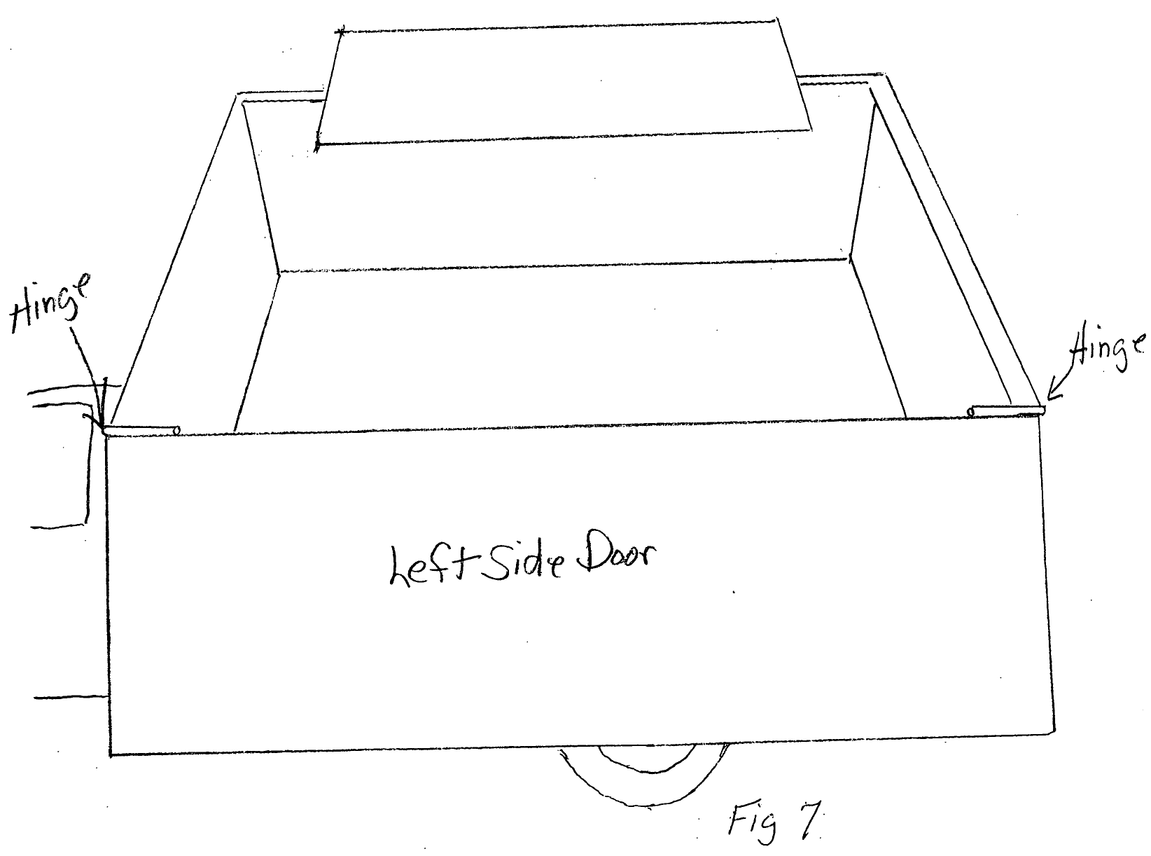

Referring to FIG. 7 of the drawings, a truck is indicated with a view looking directly at the left side of the truck bed. The truck bed is in the fully tilted position so as to un-load debris from the deck of the truck bed onto the ground. The left side wall of the truck bed is deployed in the out-board or open position so as to allow the debris on the deck to slide off of the deck onto the ground. The hinges in the upper corners of the left side-wall allow the left sidewall to swing into the out-board or open position as the truck bed is tilted to the raised position.

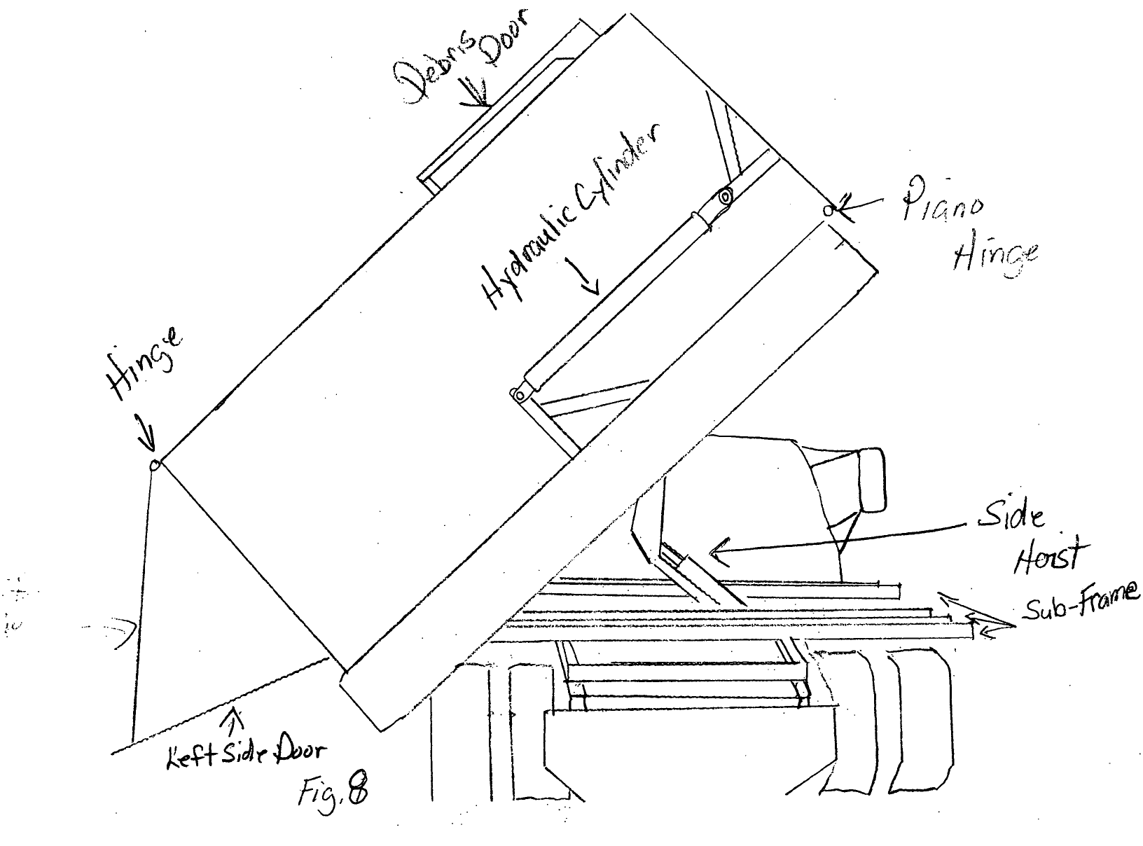

Referring to FIG. 8 of the drawings, a truck is indicated with a view of the truck bed from the rear of the truck. The truck bed is in the fully tilted position so as to un-load debris from the deck of the truck bed onto the ground. The left side wall of the truck bed is deployed in the out-board or open position so as to allow debris on the deck of the truck bed to slide off the deck on to the ground. The hinge on the upper right corner of left side wall is indicated. That hinge is one of two hinges that the left side wall pivot on to allow the left side wall to swing open to allow debris to slide off the deck onto the ground. The truck bed hydraulic hoist which tilts the deck of the truck bed is indicated. The sub-frame of the truck bed is also indicated.

What I claim:

1. I claim a debris door that is attached to the upper right wall (as opposed to the lower right wall which is attached to the deck) of the truck bed.
When using this debris door in conjunction with the previous art documented in the references cited, an economical and dependable debris handling system is made practical.
